(19) United States
(12) Patent Application Publication
(10) Pub. No.: US 2024/0400386 A1
(43) Pub. Date: Dec. 5, 2024

(54) REACTOR FOR PRODUCING HYDROGEN AND CARBON THROUGH PYROLYSIS OF METHANE BY THERMAL STORAGE METHOD, AND COMBINATION REACTOR COMPRISING SAME

(71) Applicant: KOREA INSTITUTE OF INDUSTRIAL TECHNOLOGY, Cheonan-si, Chungcheongnam-do (KR)

(72) Inventors: Uen DO LEE, Daejeon (KR); Chang Won YANG, Suwon-si, Gyeonggi-do (KR); Byung Ryeul BANG, Seoul (KR); Soo Hwa JEONG, Cheonan-si, Chungcheongnam-do (KR); Udaysinh Ingale GAYATRI, Daejeon (KR); Hyun Min KWON, Cheonan-si, Chungcheongnam-do (KR); Cheon Hyeon CHO, Cheonan-si, Chungcheongnam-do (KR); Seung Jin OH, Seongnam-si, Gyeonggi-do (KR)

(21) Appl. No.: 18/696,983

(22) PCT Filed: Sep. 29, 2021
(86) PCT No.: PCT/KR2021/013391

§ 371 Date: Apr. 30, 2024

(30) Foreign Application Priority Data
Sep. 29, 2021 (KR) 10-2021-0128847

(51) Int. Cl. C01B 3/24; B01J 6/00; B01J 19/00; B01J 19/30; C01B 32/05; C01B 32/40

(52) U.S. Cl. CPC C01B 3/24; B01J 6/008; B01J 19/0006; B01J 19/0053; B01J 19/30; C01B 32/05; C01B 32/40; B01J 2219/0004; B01J 2219/0006; B01J 2219/00213; C01B 2203/06; C01B 2203/0816; C01B 2203/1241; C01B 2203/1619

(57) ABSTRACT

Provided are a reactor for producing hydrogen and carbon through methane pyrolysis by a thermal storage method, and a combination reactor including the same, wherein the reactor includes a reaction unit in which pure-oxygen combustion of carbon and pyrolysis of methane are carried out, a first accommodation unit that supplies oxygen and the carbon to the reaction unit or accommodates carbon and hydrogen obtained by the pyrolysis of the methane, a flame supply unit that generates a flame within the reaction unit, a thermal storage unit that is located within the reaction unit and stores combustion heat generated during the pure-oxygen combustion of the carbon, and a second accommodation unit that accommodates carbon dioxide produced by the pure-oxygen combustion of the carbon or supplies methane to the reaction unit, wherein the pure-oxygen combustion of the carbon and the pyrolysis of the methane are alternately carried out.

### TECHNICAL FIELD

The disclosure relates to a reactor for producing hydrogen and carbon through methane pyrolysis by a thermal storage method, and a combination reactor including the same, and more specifically, to a reactor for producing hydrogen and carbon through methane pyrolysis by a thermal storage method, in which pure-oxygen combustion of carbon, methane pyrolysis, and the Boudouard reaction for producing high-purity carbon monoxide are carried out to enable an efficient operation and improvement in energy efficiency, and a combination reactor including the same.

### BACKGROUND ART

Currently, hydrogen production technology utilizing hydrocarbons is steam methane reforming (SMR), which is a method of reacting methane and water vapor at high temperature by utilizing a catalyst and accounts for 95% of commercial hydrogen production excluding by-product hydrogen generated in steel and petrochemical processes.

An SMR reaction is grey hydrogen production technology that generates 1 kg of hydrogen and about 13 kg of carbon dioxide when power is used in PSA for hydrogen separation after a reforming reaction to CH₄+2H₂O=4H₂+CO₂, and thus is not sustainable without removing CO₂ through CCUS technology.

Recently, there has been active development of technology for producing hydrogen and solid-state carbon through direct methane pyrolysis. The chemical reaction for this process may be expressed as CH₄=2H₂+C(s), wherein because hydrocarbon in methane is produced as solid-state carbon, there is no generation of carbon dioxide, and there is an advantage in that additional added value may be obtained through the production of high-value carbon materials.

Methane pyrolysis, which is a representative endothermic reaction, is activated between 900° C. to 1,200° C., and the conversion rate of methane approaches 100% as the temperature increases.

Methane pyrolysis techniques for this include techniques using liquid metal and molten salt, techniques using plasma, and techniques using a solid catalyst.

However, techniques using liquid metal and molten salt have limitations in heating a liquid medium to high temperatures and have problems of requiring a separate process to improve the purity of carbon because liquid metal or molten salt is smeared on solid carbon.

In addition, techniques using plasma require the generation of a huge amount of regenerative power and have problems of requiring techniques to collect carbon generated at an atomic level.

Furthermore, techniques using a solid catalyst have problems of a rapid decrease in catalyst activity due to a coking phenomenon in which carbon generated during pyrolysis adheres to the surface of a catalyst.

Meanwhile, the reaction CH₄=2H₂+C(s) yields 4 kg of hydrogen and 12 kg of carbon when 16 kg of methane is supplied. At this time, the amount of carbon thus produced is very large, and accordingly, there is a problem in that the amount of production of solid carbon may be greater than the current demand in the carbon market when a large amount of methane is reformed to produce hydrogen.

Therefore, in addition to techniques appropriately utilizing carbon in forms other than pure solid carbon materials, techniques utilizing a liquid catalyst, such as liquid metal or molten salt, using plasma, or utilizing an iron oxide, nickel or carbon-based solid catalyst have been proposed in order to implement the above-described methane pyrolysis. However, due to their low technological level, further technological development is needed for commercialization.
(Patent Document 1) KR 10-2258738 (May 25, 2021)
(Patent Document 2) KR 10-2105036 (Apr. 21, 2020)

### DISCLOSURE

### Technical Problem

In order to solve the above-described problems, the disclosure aims to provide a reactor for producing hydrogen and carbon through methane pyrolysis by a thermal storage method, which improves energy efficiency by storing, in a thermal storage unit, combustion heat generated during a process of pure-oxygen combustion of carbon and then utilizing the combustion heat during methane pyrolysis, and a combination reactor including the same.

In addition, in order to solve the above-described problems, the disclosure aims to provide a reactor for producing hydrogen and carbon through methane pyrolysis by a thermal storage method, which enables efficient process operation by allowing pure-oxygen combustion of carbon and methane pyrolysis to be alternately carried out in one reactor, and a combination reactor including the same.

In addition, in order to solve the above-described problems, the disclosure aims to provide a reactor for producing hydrogen and carbon through methane pyrolysis by a thermal storage method, which may conveniently obtain high-purity carbon monoxide by allowing the Boudouard reaction to be carried out to selectively supply carbon to carbon dioxide, and a combination reactor including the same.

However, technical objectives to be achieved by the disclosure are not limited thereto, and other technical objectives that are not mentioned may be clearly understood by those skilled in the art from the following description.

### Technical Solution

In order to achieve the above-described objectives, the disclosure provides a reactor for producing hydrogen and carbon through methane pyrolysis by a thermal storage method, the reactor including: a reaction unit in which pure-oxygen combustion of carbon and pyrolysis of methane are carried out: a first accommodation unit that supplies oxygen and the carbon to the reaction unit or accommodates carbon and hydrogen obtained by the pyrolysis of the methane; a flame supply unit that generates a flame within the reaction unit: a thermal storage unit that is located within the reaction unit and stores combustion heat generated during the pure-oxygen combustion of the carbon; and a second accommodation unit that accommodates carbon dioxide produced by the pure-oxygen combustion of the carbon or supplies methane to the reaction unit, wherein the pure-oxygen combustion of the carbon and the pyrolysis of the methane are alternately carried out.

In order to achieve the above-described objectives, the disclosure provides a reactor for producing hydrogen and carbon through methane pyrolysis by a thermal storage method, the reactor including: a reaction unit in which pure-oxygen combustion of carbon, pyrolysis of methane, and a Boudouard reaction for producing carbon monoxide are carried out: a first accommodation unit that supplies the carbon and oxygen to the reaction unit, accommodates carbon and hydrogen obtained by the pyrolysis of the methane, or supplies carbon dioxide to the reaction unit: a flame supply unit that generates a flame within the reaction unit: a thermal storage unit that is located within the reaction unit and stores combustion heat generated during the pure-oxygen combustion of the carbon; and a second accommodation unit that accommodates carbon dioxide produced by the pure-oxygen combustion of the carbon, supplies methane to the reaction unit, or accommodates the carbon monoxide, wherein the pure-oxygen combustion of the carbon, the pyrolysis of the methane, and the Boudouard reaction are sequentially carried out.

In order to achieve the above-described objectives, the disclosure provides a combination reactor for producing hydrogen and carbon through methane pyrolysis by a thermal storage method, the combination reactor including: the reactor for producing hydrogen and carbon through methane pyrolysis by a thermal storage method, as described above; and an additional reactor for producing hydrogen and carbon through methane pyrolysis by a thermal storage method, wherein the additional reactor includes: an additional reaction unit in which an additional Boudouard reaction using the carbon dioxide supplied from the second accommodation unit, additional pyrolysis of methane, and additional pure-oxygen combustion of carbon are carried out; an additional first accommodation unit that supplies the carbon dioxide supplied from the second accommodation unit to the additional reaction unit, accommodates carbon and hydrogen produced by the additional pyrolysis of the methane, or supplies carbon and oxygen for the additional pure-oxygen combustion to the additional reaction unit: an additional flame supply unit that generates a flame within the additional reaction unit: an additional thermal storage unit that is located within the additional reaction unit and stores additional combustion heat generated during the additional pure-oxygen combustion of the carbon; and an additional second accommodation unit that accommodates carbon monoxide produced by the additional Boudouard reaction, supplies methane for the additional pyrolysis of the methane to the additional reaction unit, or accommodates carbon dioxide produced by the additional pure-oxygen combustion of the carbon.

In an embodiment of the disclosure, the reactor may further include: a sensor unit that measures a temperature of the thermal storage unit; and a control unit that controls the reaction unit to operate in any one mode among a combustion mode and a pyrolysis mode according to a result of comparing the temperature of the thermal storage unit, which is transmitted from the sensor unit, with a preset pyrolysis temperature, wherein the preset pyrolysis temperature may be 1,000° C.

In an embodiment of the disclosure, the control unit may control the reaction unit to operate from the combustion mode to the pyrolysis mode when the temperature of the thermal storage unit is greater than the preset pyrolysis temperature.

In an embodiment of the disclosure, the reactor may further include: a sensor unit that measures a temperature of the thermal storage unit; and a control unit that controls the reaction unit to operate in any one mode among a combustion mode and a pyrolysis mode according to a result of comparing the temperature of the thermal storage unit, which is transmitted from the sensor unit, with a preset pyrolysis temperature, wherein the control unit may control the reaction unit to operate in a Boudouard reaction mode after the reaction unit operates in the pyrolysis mode.

In an embodiment of the disclosure, the preset pyrolysis temperature may be 1,000° C., and the control unit may control the reaction unit to operate from the combustion mode to the pyrolysis mode when the temperature of the thermal storage unit is greater than the preset pyrolysis temperature.

In an embodiment of the disclosure, the reaction unit may produce carbon monoxide through the Boudouard reaction by using the carbon dioxide supplied from the first accommodation unit.

In an embodiment of the disclosure, the first accommodation unit may additionally supply carbon to the reaction unit.

In an embodiment of the disclosure, the reaction unit may produce carbon dioxide through the pure-oxygen combustion of the carbon by supplying the flame generated from the flame supply unit to the carbon and oxygen supplied from the first accommodation unit, and the thermal storage unit may store the combustion heat generated during the pure-oxygen combustion of the carbon.

In an embodiment of the disclosure, the reaction unit may produce carbon and hydrogen through pyrolysis of the methane supplied from the second accommodation unit, and the thermal storage unit supplies, to the reaction unit, the combustion heat that is required for the pyrolysis of the methane.

In an embodiment of the disclosure, the additional reaction unit may receive, from the reaction unit, the carbon dioxide produced during the pure-oxygen combustion of the carbon and then produce carbon monoxide through the additional Boudouard reaction.

In an embodiment of the disclosure, the reaction unit may receive, from the additional reaction unit, the carbon dioxide produced during the additional pure-oxygen combustion of the carbon and then produce carbon monoxide through the Boudouard reaction.

### Advantageous Effects

The effect of the disclosure according to the above-described configuration is that energy efficiency can be improved by storing, in a thermal storage unit, combustion heat generated during a process of pure-oxygen combustion of carbon and then utilizing the combustion heat during methane pyrolysis.

In addition, the effect of the disclosure according to the above-described configuration is that efficient process operation can be facilitated by allowing pure-oxygen combustion of carbon and methane pyrolysis to be alternately carried out in one reactor.

In addition, the effect of the disclosure according to the above-described configuration is that high-purity carbon monoxide can be conveniently obtained by allowing the Boudouard reaction to be carried out to selectively supply carbon to carbon dioxide.

The effects of the disclosure are not limited thereto, and it is to be understood to encompass all effects that can be inferred from the detailed description of the disclosure or the features of the disclosure as set forth in the appended claims.

### DESCRIPTION OF DRAWINGS

FIG. 1 is a block diagram illustrating a reactor for producing hydrogen and carbon through methane pyrolysis by a thermal storage method, according to first and second embodiments of the disclosure.

(a) and (b) of FIG. 2 are conceptual diagrams illustrating that pure-oxygen combustion of carbon and methane pyrolysis are carried out in the reactor for producing hydrogen and carbon through methane pyrolysis by a thermal storage method, according to the first embodiment of the disclosure.

(a) and (b) of FIG. 3 are conceptual diagrams illustrating that pure-oxygen combustion of carbon, methane pyrolysis, and the Boudouard reaction are carried out in the reactor for producing hydrogen and carbon through methane pyrolysis by a thermal storage method, according to the second embodiment of the disclosure.

FIG. 4 is a block diagram illustrating a reactor for producing hydrogen and carbon through methane pyrolysis by a thermal storage method, according to a third embodiment of the disclosure.

FIG. 5 is a conceptual diagram illustrating that pure-oxygen combustion of carbon, methane pyrolysis, and the Boudouard reaction are carried out in the combination reactor for producing hydrogen and carbon through methane pyrolysis by a thermal storage method, according to the third embodiment of the disclosure.

### MODE FOR INVENTION

Hereinafter, the disclosure is described with reference to the accompanying drawings. However, the disclosure may be embodied in different ways and thus is not limited to embodiments described herein. In addition, in order to clearly explain the disclosure in the drawings, irrelevant descriptions are omitted, and throughout the specification, like reference numerals may denote like elements.

Throughout the specification, when an element is referred to as being “connected to (accessed to, in contact with, coupled to)” another element, the element may be “directly connected to” the other element, or the element may also be “indirectly connected to” the other element with an intervening element therebetween. In addition, when an element is referred to as “including” or “comprising” another element, unless otherwise stated, the element may further include or comprise yet another element rather than preclude the yet other element.

The terms used in the present specification are only used to describe specific embodiments and are not intended to limit the disclosure. The expression of singularity includes the expression of plurality unless clearly specified otherwise in context. In the present specification, it is to be understood that the terms such as “including.” “comprising.” or “having” are intended to indicate the existence of the features, numbers, steps, operations, elements, parts, or combinations thereof disclosed in the specification, and are not intended to preclude the possibility that one or more other features, numbers, steps, operations, elements, parts, or combinations thereof may exist or may be added.

Hereinafter, the embodiments of the disclosure are described in detail with reference to the accompanying drawings.

### 1. First Embodiment: Reactor for Producing Hydrogen and Carbon Through Methane Pyrolysis by Thermal Storage Method-Pure-Oxygen Combustion of Carbon, Methane Pyrolysis

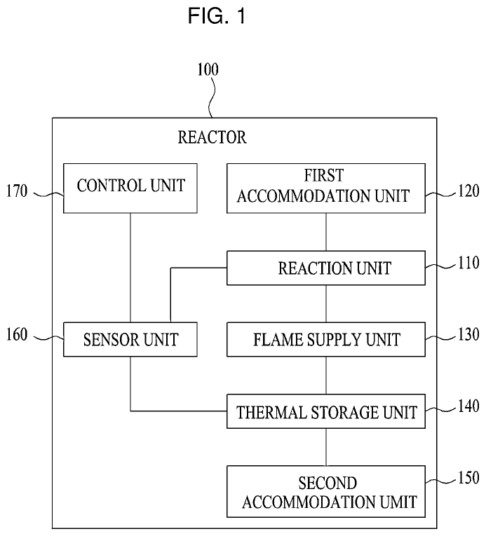

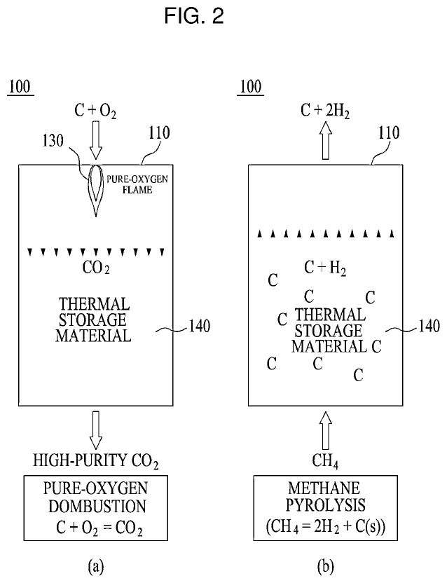

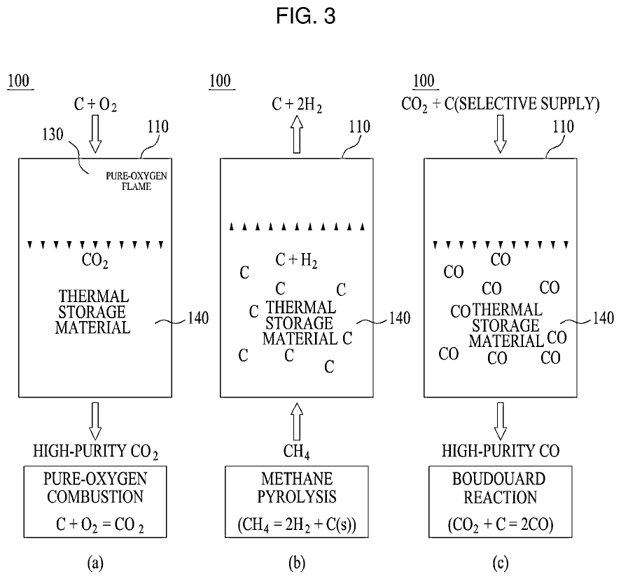

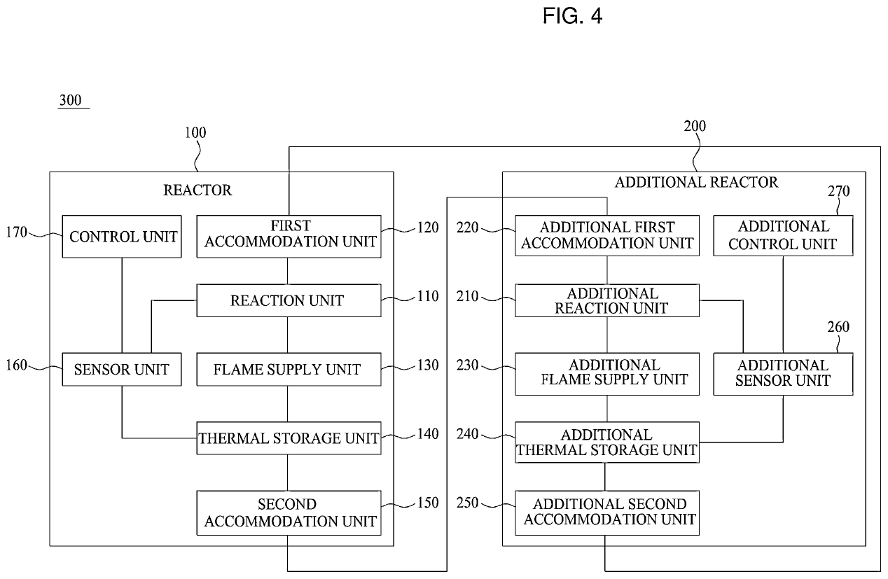

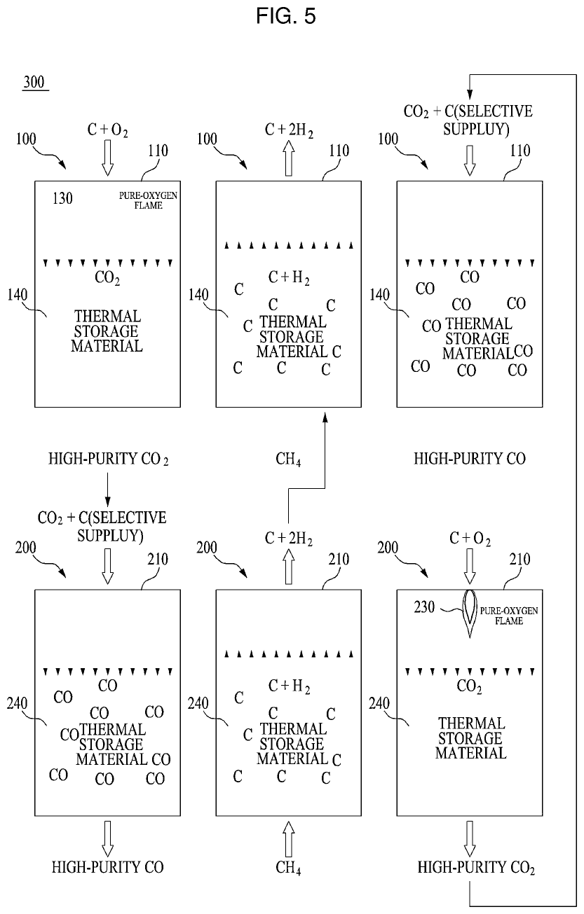

Hereinafter, a reactor for producing hydrogen and carbon through methane pyrolysis by a thermal storage method, according to a first embodiment of the disclosure, is described with reference to FIGS. 1 and 2.

FIG. 1 is a block diagram illustrating a reactor for producing hydrogen and carbon through methane pyrolysis by a thermal storage method, according to first and second embodiments of the disclosure.

A reactor 100 for producing hydrogen and carbon through methane pyrolysis by a thermal storage method, according to the first embodiment of the disclosure, includes a reaction unit 110, a first accommodation unit 120, a flame supply unit 130, a thermal storage unit 140, a second accommodation unit 150, a sensor unit 160, and a control unit 170, and pure-oxygen combustion of carbon and methane pyrolysis are alternately carried out.

(a) and (b) of FIG. 2 are conceptual diagrams illustrating that pure-oxygen combustion of carbon and methane pyrolysis are carried out in the reactor for producing hydrogen and carbon through methane pyrolysis by a thermal storage method, according to the first embodiment of the disclosure.

In the reaction unit 110, pure-oxygen combustion of carbon shown in (a) of FIG. 2 and methane pyrolysis shown in (b) of FIG. 2 are carried out.

The first accommodation unit 120 is located above the reaction unit 110 and communicates with an upper portion of the reaction unit 110.

The first accommodation unit 120 supplies oxygen and carbon to the reaction unit 110, as expressed above the reaction unit 110 in (a) of FIG. 2, or accommodates carbon and hydrogen obtained by the methane pyrolysis, as expressed above the reaction unit 110 in (b) of FIG. 2.

The flame supply unit 130 generates a flame within the reaction unit 110.

At least a portion of the flame supply unit 130 may be located within the reaction unit 110 and may be arranged to face the thermal storage unit 140.

The flame supply unit 130 generates a flame during pure-oxygen combustion of carbon and supplies the flame into the reaction unit 110, thereby allowing a pure-oxygen combustion reaction of carbon to be carried out.

The thermal storage unit 140 is located within the reaction unit 110 and stores combustion heat generated during pure-oxygen combustion of carbon.

Specifically, the thermal storage unit 140 is located to face the flame supply unit 130 as shown in (a) and (b) of FIG. 2, and is arranged in an internal space of the reaction unit 110 excluding a space for pure-oxygen combustion of carbon.

The second accommodation unit 150 is located under the reaction unit 110 and communicates with a lower portion of the reaction unit 110.

The second accommodation unit 150 accommodates carbon dioxide produced by pure-oxygen combustion of carbon or supplies methane to the reaction unit 110.

The sensor unit 160 measures the temperature of the thermal storage unit 140 and transmits the measured temperature of the thermal storage unit 140 to the control unit 170.

In addition, the sensor unit 160 may measure the total amount of heat generated during pure-oxygen combustion of carbon and transmit the measured total amount of heat to the control unit 170.

The control unit 170 controls the reaction unit 110 to operate in any one mode among a combustion mode shown in (a) of FIG. 2 and a pyrolysis mode shown in (b) of FIG. 2 according to a result of comparing the temperature of the thermal storage unit, which is transmitted from the sensor unit 160, with a preset pyrolysis temperature.

At this time, the preset pyrolysis temperature is preferably 1,000° C. to maintain a high-temperature endothermic reaction.

When the temperature of the thermal storage unit 140 is greater than the preset pyrolysis temperature, the control unit 170 controls the reaction unit 110 to operate from the combustion mode to the pyrolysis mode.

Meanwhile, when the temperature of the thermal storage unit 140 is less than the preset pyrolysis temperature, the control unit 170 determines that a state of the reaction unit 110 does not satisfy a pyrolysis condition to be provided for an endothermic reaction required for a pyrolysis reaction, and controls the reaction unit 110 to maintain the combustion mode that is currently activated.

Hereinafter, a process of pure-oxygen combustion of carbon and a process of methane pyrolysis are described with reference to (a) and (b) of FIG. 2.

Referring to (a) of FIG. 2, the first accommodation unit 120 supplies carbon and oxygen to the reaction unit 110, and the flame supply unit 130 generates a flame and supplies the flame into the reaction unit 110.

Accordingly, the reaction unit 110 produces carbon dioxide (CO₂) through pure-oxygen combustion of carbon by supplying a flame generated by the flame supply unit 130 to carbon (C) and oxygen (O₂), which are supplied from the first accommodation unit 120. At this time, the carbon dioxide thus produced is high-purity carbon dioxide.

In addition, the thermal storage unit 140 stores combustion heat generated during pure-oxygen combustion of carbon, and then, when a methane pyrolysis reaction is carried out in the reaction unit 110, the thermal storage unit 140 supplies the stored combustion heat to the reaction unit 110 to support the methane pyrolysis reaction.

Meanwhile, referring to (b) of FIG. 2, the second accommodation unit 150 supplies methane (CH₄) to the reaction unit 110, and the thermal storage unit 140 supplies, to the reaction unit 110, combustion heat (=heat required for methane pyrolysis) stored during pure-oxygen combustion of carbon.

Accordingly, the reaction unit 110 produces carbon (C) and hydrogen (2H₂) through pyrolysis of methane supplied from the second accommodation unit 150.

### 2. Second Embodiment: Reactor for Producing Hydrogen and Carbon Through Methane Pyrolysis by Thermal Storage Method-Pure-Oxygen Combustion of Carbon, Methane Pyrolysis, Boudouard Reaction

Hereinafter, the reactor for producing hydrogen and carbon through methane pyrolysis by a thermal storage method, according to the second embodiment of the disclosure, is described with reference to FIGS. 1 and 3.

The reactor 100 for producing hydrogen and carbon through methane pyrolysis by a thermal storage method, according to the second embodiment of the disclosure, has the same components as the first embodiment, and thus, detailed description thereof is as described above.

However, in the reactor 100 for producing hydrogen and carbon through methane pyrolysis by a thermal storage method, according to the second embodiment, the Boudouard reaction is additionally carried out in addition to the process of pure-oxygen combustion of carbon and the process of methane pyrolysis, which are carried out in the first embodiment. Thus, technical features related to the Boudouard reaction is described in detail.

(a) and (b) of FIG. 3 are conceptual diagrams illustrating that pure-oxygen combustion of carbon, methane pyrolysis, and the Boudouard reaction are carried out in the reactor for producing hydrogen and carbon through methane pyrolysis by a thermal storage method, according to the second embodiment of the disclosure.

The reactor 100 for producing hydrogen and carbon through methane pyrolysis by a thermal storage method, according to the second embodiment of the disclosure, includes the reaction unit 110, the first accommodation unit 120, the flame supply unit 130, the thermal storage unit 140, the second accommodation unit 150, the sensor unit 160, and the control unit 170, and pure-oxygen combustion of carbon and methane pyrolysis are alternately carried out.

In addition, the disclosure is characterized in that pure-oxygen combustion of carbon, methane pyrolysis, and the Boudouard reaction are sequentially carried out.

In the reaction unit 110, pure-oxygen combustion of carbon, methane pyrolysis, and the Boudouard reaction for producing carbon monoxide are carried out.

In the reaction unit 110, the Boudouard reaction that does not occur in the reaction unit 110 of the first embodiment further occurs, and other components and operations are the same as those of the reaction unit 110 of the first embodiment and thus are as described above.

The first accommodation unit 120 supplies carbon (C) and oxygen (O₂), shown in (a) of FIG. 3, to the reaction unit 110, accommodates carbon (C) and hydrogen (2H₂) obtained by pyrolysis of methane (CH₄) shown in (b) of FIG. 3, or supplies carbon dioxide (CO₂) shown in (c) of FIG. 3 to the reaction unit 110.

In addition, the first accommodation unit 120 may selectively supply additional carbon (C) together with carbon dioxide (CO₂) during the Boudouard reaction as shown in (c) of FIG. 3.

The first accommodation unit 120 differs from the first accommodation unit 120 of the first embodiment in that the former supplies carbon dioxide to the reaction unit 110 for the purpose of the Boudouard reaction.

The flame supply unit 130 generates a flame within the reaction unit 110, and the flame supply unit 130 is the same as the flame supply unit 130 of the first embodiment, and thus, detailed description thereof is as described above.

The thermal storage unit 140 is located within the reaction unit 110 and stores combustion heat generated during pure-oxygen combustion of carbon, and the thermal storage unit 140 is the same as the thermal storage unit 140 of the first embodiment, and thus, detailed description thereof is as described above.

The second accommodation unit 150 accommodates carbon dioxide (CO₂) produced by pure-oxygen combustion of carbon (C) shown in (a) of FIG. 3, supplies methane (CH₄) to the reaction unit 110 shown in (b) of FIG. 3, or accommodates carbon monoxide (CO) shown in (c) of FIG. 3.

As shown in (c) of FIG. 3, when the Boudouard reaction occurs in the reaction unit 110, the second accommodation unit 150 accommodates carbon monoxide produced in the reaction unit 110 by the Boudouard reaction, and at this time, the carbon monoxide is high-purity carbon monoxide.

In addition, functions of the second accommodation unit 150 related to pure-oxygen combustion of carbon and methane pyrolysis, which are shown in (a) and (b) of FIG. 3, are the same as those of the second accommodation unit 150 of the first embodiment, and thus, detailed description thereof is as described above.

The sensor unit 160 measures the temperature of the thermal storage unit 140, and the sensor unit 160 is the same as the sensor unit 160 of the first embodiment, and thus, detailed description thereof is as described above.

The control unit 170 controls the reaction unit 110 to operate in any one mode among a combustion mode and a pyrolysis mode according to a result of comparing the temperature of the thermal storage unit 140, which is transmitted from the sensor unit 160, with a preset pyrolysis temperature.

At this time, the preset pyrolysis temperature is 1,000° C., and when the temperature of the thermal storage unit 140 is greater than the preset pyrolysis temperature, the control unit 170 controls the reaction unit 110 to operate from the combustion mode to the pyrolysis mode.

In particular, the control unit 170 differs from the control unit 170 of the first embodiment in that the former controls the reaction unit 110 to operate in a Boudouard reaction mode after the reaction unit 110 operates in the pyrolysis mode.

Regarding the Boudouard reaction shown in (c) of FIG. 3, the reaction unit 110 produces carbon monoxide (CO) through the Boudouard reaction by using carbon dioxide (CO₂) supplied from the first accommodation unit 120.

In addition, depending on circumstances, the first accommodation unit 120 may supply additional carbon (C) to the reaction unit 110.

Except for the technical features related to the Boudouard reaction, the control unit 170 is the same as the control unit 170 of the first embodiment, and thus, detailed description thereof is as described above.

### 3. Third Embodiment: Combination Reactor for Producing Hydrogen and Carbon Through Methane Pyrolysis by Thermal Storage Method-Including Reactor and Additional Reactor (Pure-Oxygen Combustion of Carbon, Methane Pyrolysis)

Hereinafter, a combination reactor for producing hydrogen and carbon through methane pyrolysis by a thermal storage method, according to a third embodiment of the disclosure, is described with reference to FIGS. 1 to 5.

The combination reactor for producing hydrogen and carbon through methane pyrolysis by a thermal storage method, according to the third embodiment, is a combination of two reactors: the reactor for producing hydrogen and carbon through methane pyrolysis by a thermal storage method, according to the second embodiment; and the other reactor, which is expressed as additional reactor for convenience of explanation of the disclosure.

FIG. 4 is a block diagram illustrating a reactor for producing hydrogen and carbon through methane pyrolysis by a thermal storage method, according to the third embodiment of the disclosure.

Referring to FIG. 4, a combination reactor 300 for producing hydrogen and carbon through methane pyrolysis by a thermal storage method, according to the third embodiment of the disclosure, includes: the reactor 100 for producing hydrogen and carbon through methane pyrolysis by a thermal storage method; and an additional reactor 200 for producing hydrogen and carbon through methane pyrolysis by a thermal storage method, wherein the reactor 100 and the additional reactor 200 include the same subcomponents.

The reactor 100 includes the reaction unit 110, the first accommodation unit 120, the flame supply unit 130, the thermal storage unit 140, the second accommodation unit 150, the sensor unit 160, and the control unit 170.

The reactor 100 is the same as the reactor 100 of the second embodiment, and thus, detailed description thereof is not provided and is as described above.

FIG. 5 is a conceptual diagram illustrating that pure-oxygen combustion of carbon, methane pyrolysis, and the Boudouard reaction are carried out in the combination reactor for producing hydrogen and carbon through methane pyrolysis by a thermal storage method, according to the third embodiment of the disclosure.

The additional reactor 200 includes an additional reaction unit 210, an additional first accommodation unit 220, an additional flame supply unit 230, an additional thermal storage unit 240, an additional second accommodation unit 250, an additional sensor unit 160, and an additional control unit 170.

The additional reaction unit 210, the additional first accommodation unit 220, the additional flame supply unit 230, the additional thermal storage unit 240, the additional second accommodation unit 250, the additional sensor unit 160, and the additional control unit 170 are the same as the reaction unit 110, the first accommodation unit 120, the flame supply unit 130, the thermal storage unit 140, the second accommodation unit 150, the sensor unit 160, and the control unit 170, of the second embodiment, and thus, detailed description thereof is as described above and is briefly provided.

Referring to FIG. 5, in the additional reaction unit 210, an additional Boudouard reaction using carbon dioxide (CO₂) supplied from the second accommodation unit 150, an additional pyrolysis of methane, and an additional pure-oxygen combustion of carbon are carried out.

The additional first accommodation unit 220 supplies, to the additional reaction unit 210, carbon dioxide (CO₂) supplied from the second accommodation unit 150, accommodates carbon (C) and hydrogen (H₂) produced by the additional pyrolysis of methane (CH₄), or supplies, to the additional reaction unit 210, carbon (C) and oxygen (O₂) for the purpose of the additional pure-oxygen combustion.

The additional flame supply unit 230 generates a flame within the additional reaction unit 210.

The additional thermal storage unit 240 is located within the additional reaction unit 210 and stores additional combustion heat generated during the additional pure-oxygen combustion of carbon.

The additional second accommodation unit 250 accommodates carbon monoxide (CO) produced by the additional Boudouard reaction, supplies methane (CH₄) for the additional pyrolysis of methane to the additional reaction unit 210, or accommodates carbon dioxide (CO₂) produced by the additional pure-oxygen combustion of carbon.

The additional sensor unit 260 measures the temperature of the additional thermal storage unit 240, and the sensor unit 260 is the same as the sensor unit 160 of the second embodiment, and thus, detailed description thereof is as described above.

The additional control unit 270 controls the additional reaction unit 210 to operate in any one mode among a combustion mode and a pyrolysis mode according to a result of comparing the temperature of the additional thermal storage unit 240, which is transmitted from the additional sensor unit 260, with a preset pyrolysis temperature.

At this time, the preset pyrolysis temperature is 1,000° C., and when the temperature of the additional thermal storage unit 240 is greater than the preset pyrolysis temperature, the additional control unit 270 controls the additional reaction unit 210 to operate from the combustion mode to the pyrolysis mode.

The additional control unit 270 is the same as the control unit 170 of the second embodiment, and thus, detailed description thereof is as described above.

Hereinafter, operations of the combination reactor for producing hydrogen and carbon through methane pyrolysis by a thermal storage method, according to the third embodiment of the disclosure, are described with reference to FIG. 5.

First, regarding the pure-oxygen combustion of carbon, when carbon (C) and oxygen (O₂) are supplied to the reaction unit 110, the reaction unit 110 produces high-purity carbon dioxide (CO₂) through pure-oxygen combustion of carbon (C) by using a flame generated by the flame supply unit 130. The high-purity carbon dioxide thus produced is utilized during the Boudouard reaction that occurs in the additional reaction unit 210 as shown in FIG. 5.

In addition, when carbon (C) and oxygen (O₂) are supplied to the additional reaction unit 210, the additional reaction unit 210 produces high-purity carbon dioxide (CO₂) through pure-oxygen combustion of carbon (C) by using a flame generated by the additional flame supply unit 230. The high-purity carbon dioxide (CO₂) thus produced is utilized during the Boudouard reaction that occurs in the reaction unit 110 as shown in FIG. 5.

Next, regarding the methane pyrolysis, when methane (CH₄) is supplied to the reaction unit 110, combustion heat stored in the thermal storage unit 140 is supplied to the reaction unit 110, resulting in methane pyrolysis, thereby producing carbon (C) and hydrogen (2H₂).

In addition, when methane (CH₄) is supplied to the additional reaction unit 210, combustion heat stored in the additional thermal storage unit 240 is supplied to the additional reaction unit 210, resulting in methane pyrolysis, thereby producing carbon (C) and hydrogen (2H₂).

In other words, the additional reaction unit 210 receives, from the reaction unit 110, carbon dioxide produced during the pure-oxygen combustion of carbon and then produces carbon monoxide through the additional Boudouard reaction.

In addition, the reaction unit 110 receives, from the additional reaction unit 210, carbon dioxide produced during the additional pure-oxygen combustion of carbon and then produces carbon monoxide through the Boudouard reaction.

Unlike the first and second embodiments, in the third embodiment as described above, materials (hydrogen, carbon, carbon dioxide, carbon monoxide) produced in the reactor 100 and the additional reactor 100 are supplied between them to ensure smooth and efficient operation of pure-oxygen combustion of carbon, methane pyrolysis, and the Boudouard reaction and simultaneously improve energy efficiency.

As described above, the disclosure may implement a methane pyrolysis process (CH₄=2H₂+C(s)) that efficiently solves problems that have been challenges in the prior art by utilizing a thermal storage unit which is a thermal storage material, and solutions to each challenge are as follows.

First, for the purpose of heat production and transfer in order to maintain a high-temperature endothermic reaction of 1,000° C. or more, combustion heat produced through pure-oxygen combustion using, as a fuel, some solid carbon produced through methane pyrolysis is stored, and then, high-temperature pyrolysis heat is supplied in a simple manner through a repeated process of performing methane pyrolysis by transitioning into a pyrolysis process.

Second, although some carbon generated during a pyrolysis reaction may adhere to the inner wall of a reactor and a thermal storage material, a thermal storage material is regenerated through complete combustion during a process of pure-oxygen combustion, and thus, produced carbon solids may solve the problem of the adherence to the inner wall of the reactor (thermal storage material).

Third, no separate catalyst such as a liquid catalyst, molten salt, or solid catalyst is required, and mixing of foreign substances into produced solid carbon is fundamentally prevented such that high-purity carbon may be obtained, thereby improving the quality of a solid carbon product.

Fourth, the impact of residual substances during transition between processes such as combustion and pyrolysis may be solved by separately collecting and processing gas generated at the beginning of each process (high-purity hydrogen separation process).

Fifth, when high-temperature carbon produced by pyrolysis and high-temperature carbon dioxide (CO₂) produced by pure-oxygen combustion react, high-purity carbon monoxide (CO) may be easily produced through the Boudouard reaction, and since the temperatures of both carbon generated during a methane pyrolysis process and carbon dioxide (CO₂) are 1,000° C. or more, this reaction may be easily implemented without adding a separate heat transfer process (carbon dioxide (CO₂) production process, utilization of excessively produced carbon).

Sixth, since the purity of produced carbon dioxide (CO₂) is 100%, it is advantageous in terms of CCUS applicability at the time of CCUS technology linkage.

Seventh, when a combustion-pyrolysis-CO production process is implemented along with a repeated process of combustion-pyrolysis, high-purity carbon dioxide (CO₂), high-purity hydrogen and solid carbon, and high-purity carbon monoxide (CO) may be easily obtained.

Eighth, when a plurality of reactors are utilized based on a process using a single reactor, a more constant and efficient process configuration is possible.

The description of the disclosure provided above is for illustrative purposes, and those skilled in the art will understand that the disclosure can be easily modified into other specific forms without changing the inventive concept or essential features of the disclosure. Therefore, it should be understood that the foregoing embodiments are provided for illustrative purposes only and are not to be construed in any way as limiting the disclosure. For example, each element described as a single type may be implemented in a distributed manner, and likewise, elements described as being distributed may be implemented as a combined type.

The scope of the disclosure should be defined by the appended claims, and any changes or modifications derived from the appended claims and equivalents thereof should be construed as falling within the scope of the disclosure.

### DESCRIPTION OF REFERENCE NUMERALS

100: Reactor for producing hydrogen and carbon through methane pyrolysis by a thermal storage method
110: Reaction unit
120: First accommodation unit
130: Flame supply unit
140: thermal storage unit
150: Second accommodation unit
160: Sensor unit
170: Control unit
200: Additional reactor for producing hydrogen and carbon through methane pyrolysis by a thermal storage method
210: Additional reaction unit
220: Additional first accommodation unit
230: Additional flame supply unit
240: Additional thermal storage unit
250: Additional second accommodation unit
260: Additional sensor unit
270: Additional control unit
300: Combination reactor for producing hydrogen and carbon through methane pyrolysis by a thermal storage method

1. A reactor for producing hydrogen and carbon through methane pyrolysis by a thermal storage method, the reactor comprising:
a reaction unit in which pure-oxygen combustion of carbon and pyrolysis of methane are carried out;
a first accommodation unit that supplies oxygen and the carbon to the reaction unit or accommodates carbon and hydrogen obtained by the pyrolysis of the methane;
a flame supply unit that generates a flame within the reaction unit;
a thermal storage unit that is located within the reaction unit and stores combustion heat generated during the pure-oxygen combustion of the carbon; and
a second accommodation unit that accommodates carbon dioxide produced by the pure-oxygen combustion of the carbon or supplies methane to the reaction unit,
wherein the pure-oxygen combustion of the carbon and the pyrolysis of the methane are alternately carried out.

2. A reactor for producing hydrogen and carbon through methane pyrolysis by a thermal storage method, the reactor comprising:
a reaction unit in which pure-oxygen combustion of carbon, pyrolysis of methane, and a Boudouard reaction for producing carbon monoxide are carried out;
a first accommodation unit that supplies the carbon and oxygen to the reaction unit, accommodates carbon and hydrogen obtained by the pyrolysis of the methane, or supplies carbon dioxide to the reaction unit;
a flame supply unit that generates a flame within the reaction unit;
a thermal storage unit that is located within the reaction unit and stores combustion heat generated during the pure-oxygen combustion of the carbon; and
a second accommodation unit that accommodates carbon dioxide produced by the pure-oxygen combustion of the carbon, supplies methane to the reaction unit, or accommodates the carbon monoxide,
wherein the pure-oxygen combustion of the carbon, the pyrolysis of the methane, and the Boudouard reaction are sequentially carried out.

3. A combination reactor for producing hydrogen and carbon through methane pyrolysis by a thermal storage method, the combination reactor comprising:
the reactor for producing hydrogen and carbon through methane pyrolysis by a thermal storage method, of claim 2; and
an additional reactor for producing hydrogen and carbon through methane pyrolysis by a thermal storage method,
wherein the additional reactor comprises:
an additional reaction unit in which an additional Boudouard reaction using the carbon dioxide supplied from the second accommodation unit, additional pyrolysis of methane, and additional pure-oxygen combustion of carbon are carried out;
an additional first accommodation unit that supplies the carbon dioxide supplied from the second accommodation unit to the additional reaction unit, accommodates carbon and hydrogen produced by the additional pyrolysis of the methane, or supplies carbon and oxygen for the additional pure-oxygen combustion to the additional reaction unit;
an additional flame supply unit that generates a flame within the additional reaction unit;
an additional thermal storage unit that is located within the additional reaction unit and stores additional combustion heat generated during the additional pure-oxygen combustion of the carbon; and
an additional second accommodation unit that accommodates carbon monoxide produced by the additional Boudouard reaction, supplies methane for the additional pyrolysis of the methane to the additional reaction unit, or accommodates carbon dioxide produced by the additional pure-oxygen combustion of the carbon.

4. The reactor of claim 1, further comprising:
a sensor unit that measures a temperature of the thermal storage unit; and
a control unit that controls the reaction unit to operate in any one mode among a combustion mode and a pyrolysis mode according to a result of comparing the temperature of the thermal storage unit, which is transmitted from the sensor unit, with a preset pyrolysis temperature,
wherein the preset pyrolysis temperature is 1,000° C.

5. The reactor of claim 4, wherein the control unit controls the reaction unit to operate from the combustion mode to the pyrolysis mode when the temperature of the thermal storage unit is greater than the preset pyrolysis temperature.

6. The reactor of claim 2, further comprising:
a sensor unit that measures a temperature of the thermal storage unit; and
a control unit that controls the reaction unit to operate in any one mode among a combustion mode and a pyrolysis mode according to a result of comparing the temperature of the thermal storage unit, which is transmitted from the sensor unit, with a preset pyrolysis temperature,
wherein the control unit controls the reaction unit to operate in a Boudouard reaction mode after the reaction unit operates in the pyrolysis mode.

7. The reactor of claim 6, wherein the preset pyrolysis temperature is 1,000° C., and
the control unit controls the reaction unit to operate from the combustion mode to the pyrolysis mode when the temperature of the thermal storage unit is greater than the preset pyrolysis temperature.

8. The reactor of claim 2, wherein the reaction unit produces carbon monoxide through the Boudouard reaction by using the carbon dioxide supplied from the first accommodation unit.

9. The reactor of claim 8, wherein the first accommodation unit additionally supplies carbon to the reaction unit.

10. The reactor of claim 1 or 2, wherein the reaction unit produces carbon dioxide through the pure-oxygen combustion of the carbon by supplying the flame generated from the flame supply unit to the carbon and oxygen supplied from the first accommodation unit, and
the thermal storage unit stores the combustion heat generated during the pure-oxygen combustion of the carbon.

11. The reactor of claim 1 or 2, wherein the reaction unit produces carbon and hydrogen through pyrolysis of the methane supplied from the second accommodation unit, and
the thermal storage unit supplies, to the reaction unit, the combustion heat that is required for the pyrolysis of the methane.

12. The combination reactor of claim 3, wherein the additional reaction unit receives, from the reaction unit, the carbon dioxide produced during the pure-oxygen combustion of the carbon and then produces carbon monoxide through the additional Boudouard reaction.

13. The combination reactor of claim 3, wherein the reaction unit receives, from the additional reaction unit, the carbon dioxide produced during the additional pure-oxygen combustion of the carbon and then produces carbon monoxide through the Boudouard reaction.
